(19) United States
(12) Patent Application Publication
(10) Pub. No.: US 2024/0260538 A1
(43) Pub. Date: Aug. 8, 2024

(54) MASSAGING PET BED ASSEMBLY

(71) Applicants: Nick Copeland, Fair Grove, MO (US); Clay Copeland, Fair Grove, MO (US); Debra Copeland, Fair Grove, MO (US)

(72) Inventors: Nick Copeland, Fair Grove, MO (US); Clay Copeland, Fair Grove, MO (US); Debra Copeland, Fair Grove, MO (US)

(21) Appl. No.: 18/104,870

(22) Filed: Feb. 2, 2023

(51) Int. Cl. A01K 1/035

(52) U.S. Cl. CPC A01K 1/0353

(57) ABSTRACT

A massaging pet bed assembly for enhancing comfort for a pet while the pet is lying down includes a pet bed that has a recess integrated into the pet bed to facilitate a pet to lie in the recess. A cushion is integrated into the pet bed to facilitate the pet lie on the cushion. A heating element is integrated into the pet bed to heat the pet bed for warming the pet when the pet lies on the pet bed. A vibration unit is integrated into the pet bed and the vibration unit vibrates the pet bed when the vibration unit is turned on to facilitate the pet to enjoy the sensation of vibration when the pet lies on the pet bed.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to pet bed devices and more particularly pertains to a new pet bed device for enhancing comfort for a pet while the pet is lying down. The device includes a pet bed that has a rigid panel on a bottom of the pet bed and a cushion on a top of the pet bed. The device includes a heating element for warming the pet bed and a vibration unit for vibrating the pet bed. The device includes a pressure sensor which actuates each of the vibration unit and the heating element when the pet lies on the pet bed.

### (2) Description of Related Art Including Information Disclosed Under 37 CFR 1.97 and 1.98

The prior art relates to pet bed devices including a pet bed that includes a thermoelectric unit for heating or cooling the pet bed and a platform that is removably attachable to the pet bed. The prior art discloses a portable seat that has a graphite heating element. The prior art discloses a pet bed that has a raised ring and a thermoelectric unit for warming or cooling the pet bed.

### BRIEF SUMMARY OF THE INVENTION

An embodiment of the disclosure meets the needs presented above by generally comprising a pet bed that has a recess integrated into the pet bed to facilitate a pet to lie in the recess. A cushion is integrated into the pet bed to facilitate the pet lie on the cushion. A heating element is integrated into the pet bed to heat the pet bed for warming the pet when the pet lies on the pet bed. A vibration unit is integrated into the pet bed and the vibration unit vibrates the pet bed when the vibration unit is turned on to facilitate the pet to enjoy the sensation of vibration when the pet lies on the pet bed.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a massaging pet bed assembly according to an embodiment of the disclosure.

FIG. 2 is a top perspective view of an alternative embodiment of the disclosure.

FIG. 3 is a bottom perspective view of an embodiment of the disclosure.

FIG. 4 is a cross sectional view taken along line 4-4 of FIG. 1 of an embodiment of the disclosure.

FIG. 5 is a cross sectional view taken along line 5-5 of FIG. 2 of an alternative embodiment of the disclosure.

FIG. 6 is a cross sectional view taken along line 6-6 of FIG. 5 of an alternative embodiment of the disclosure.

FIG. 7 is a perspective in-use view of an embodiment of the disclosure.

FIG. 8 is a schematic view of an embodiment of the disclosure.

FIG. 9 is a schematic view of an alternative embodiment of the disclosure.

### DETAILED DESCRIPTION OF THE INVENTION

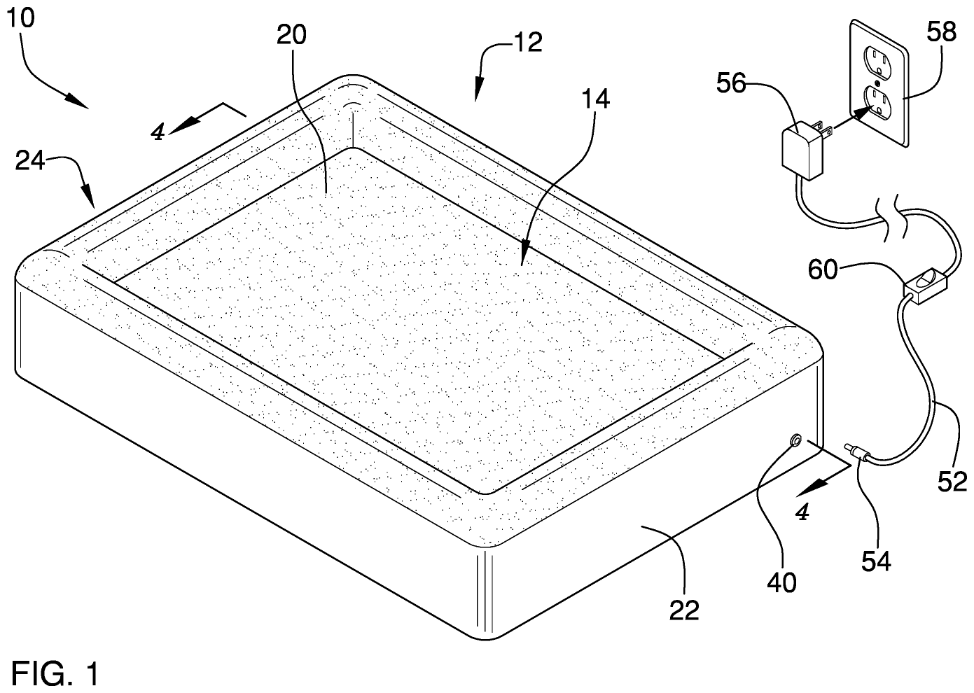

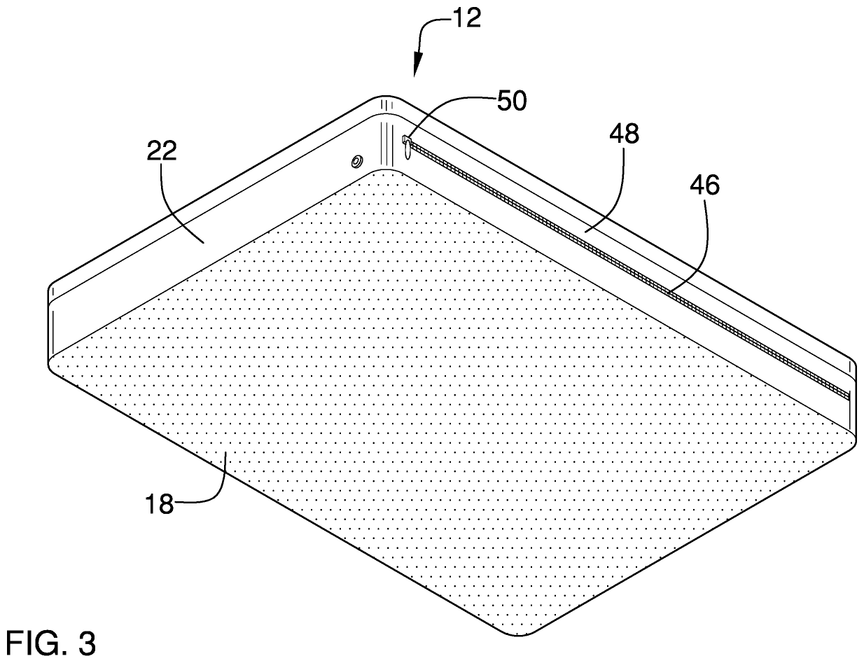

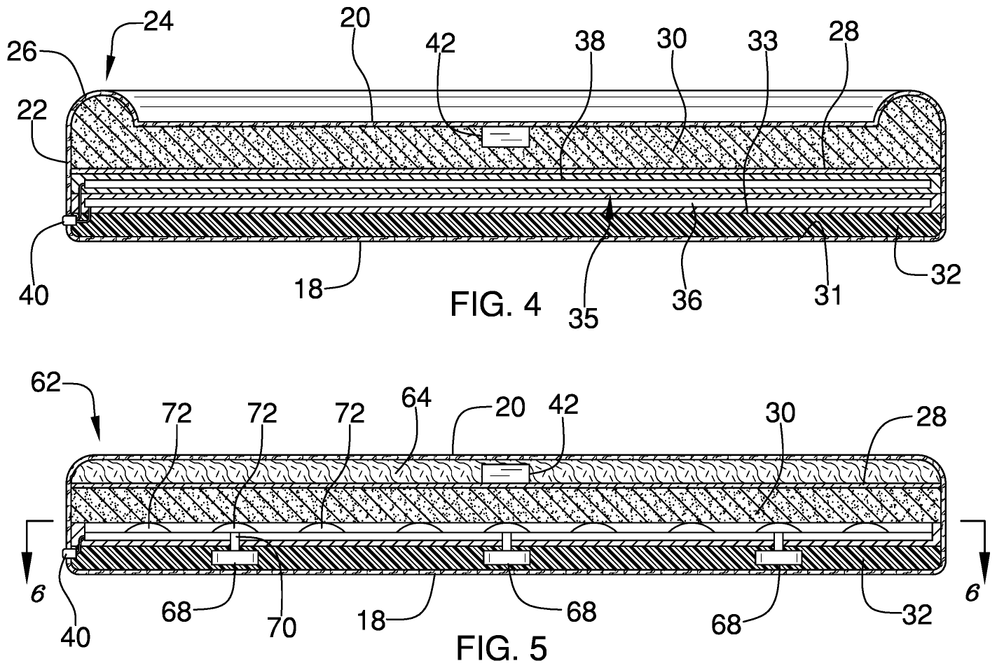

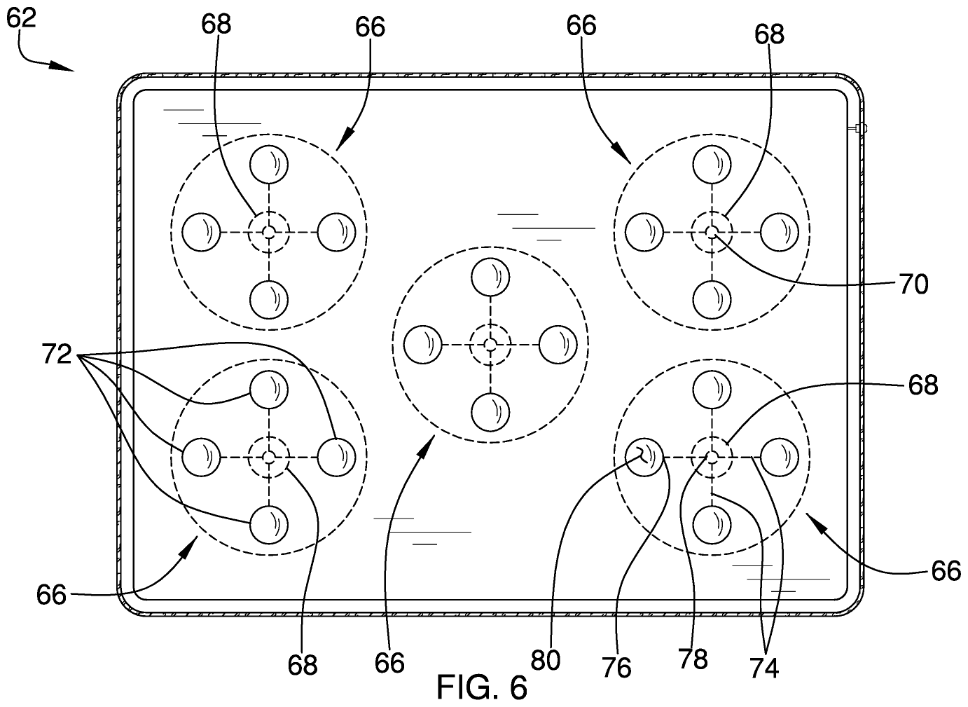

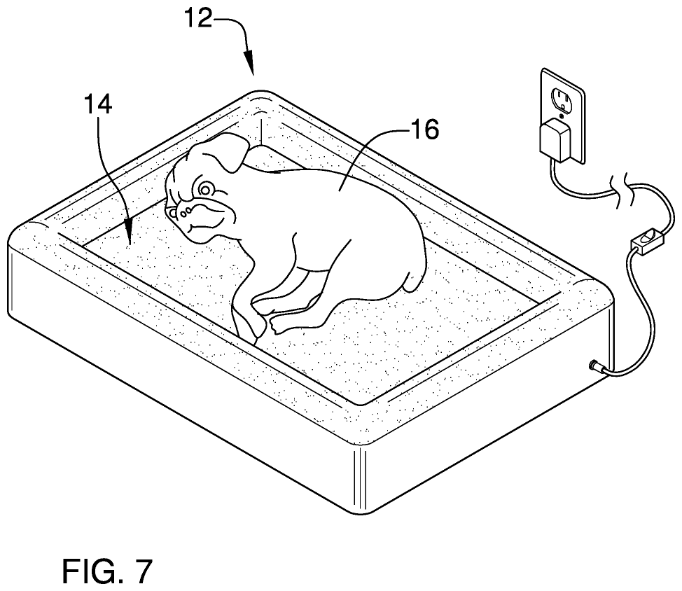

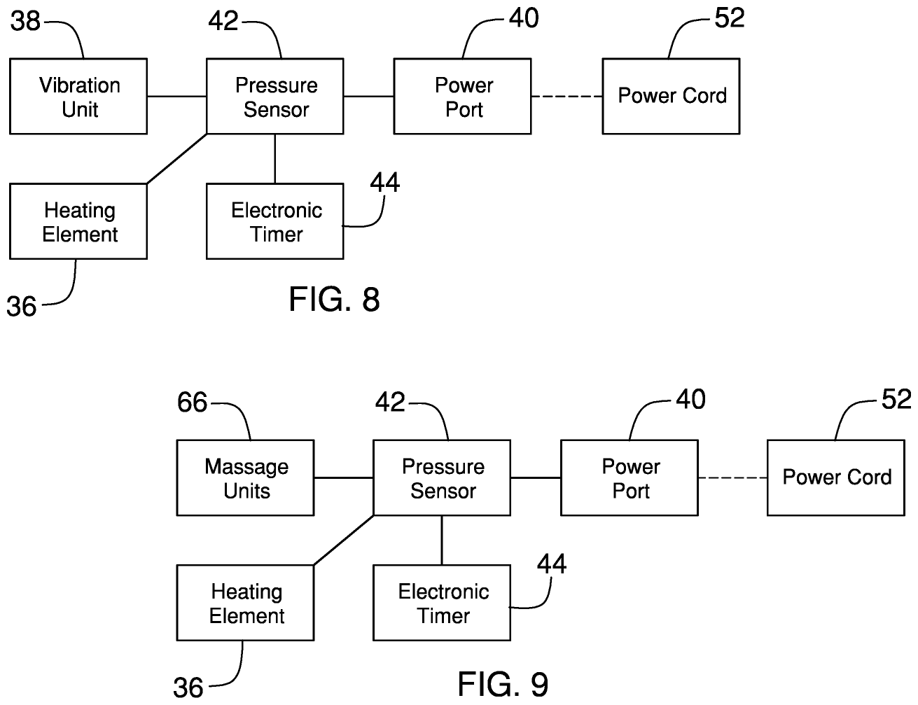

With reference now to the drawings, and in particular to FIGS. 1 through 9 thereof, a new pet bed device embodying the principles and concepts of an embodiment of the disclosure and generally designated by the reference numeral 10 will be described.

As best illustrated in FIGS. 1 through 9, the massaging pet bed assembly 10 generally comprises a pet bed 12 that has a recess 14 integrated into the pet bed 12 to facilitate a pet 16 to lie in the recess 14. The pet 16 may be a domesticated animal such as a cat or a dog. The pet bed 12 has a bottom wall 18, a top wall 20 and an outer wall 22 extending between the top wall 20 and the bottom wall 18 and the bottom wall 18 is comprised of a non-skid material to inhibit the pet bed 12 from sliding on a support surface 23 such as a floor, for example. The pet bed 12 has a prominence 24 extending upwardly from the top wall 20 and the prominence 24 extends around a full perimeter of the outer wall 22 such that the prominence 24 defines the recess 14 with respect to the top wall 20. The prominence 24 has a top end 26 that is rounded and the pet bed 12 has a dividing wall 28 that is positioned between the top wall 20 and the bottom wall 18. Furthermore, the top wall 20 and the top end 26 of the prominence may be comprised of a deformable textile, such as cotton for example, which enhances comfort for the pet 16.

A cushion 30 is integrated into the pet bed 12 to facilitate the pet 16 to lie on the cushion 30. Additionally, the cushion 30 is comprised of a resiliently compressible material to enhance comfort for the pet 16. The cushion 30 extends between the dividing wall 28 and the top wall 20 and the cushion 30 extends into the prominence 24 such that the cushion 30 fills the prominence 24. A panel 32 is provided which has a bottom side 34 resting on an upper surface 31 of the bottom wall 18 of the pet bed 12 and a top surface 33 of the panel 32 is spaced from the dividing wall 28 to define a space 35 between the panel 32 and the dividing wall 28. The panel 32 is comprised of a rigid material thereby inhibiting the bottom wall 18 of the pet bed 12 from deforming when the pet bed 12 is positioned on the support surface 23.

A heating element 36 is integrated into the pet bed 12 and the heating element 36 is in thermal communication with the pet bed 12 such that the heating element 36 heats the pet bed 12 when the heating element 36 is turned on. In this way the heating element 36 can warm the pet 16 when the pet 16 lies on the pet bed 12. The heating element 36 is positioned in the space 35 defined between the dividing wall 28 and the panel 32 and the heating element 36 may comprise an electric heating element which has an operational temperature ranging between approximately 80.0 degrees Fahrenheit and 100.0 degrees Fahrenheit.

A vibration unit 38 is integrated into the pet bed 12 and the vibration unit 38 vibrates the pet bed 12 when the vibration unit 38 is turned on to facilitate the pet 16 to enjoy the sensation of vibration when the pet 16 lies on the pet bed 12. The vibration unit 38 is positioned between the heating element 36 and the top surface of the panel 32. Additionally, the vibration unit 38 may comprise an electronic vibration unit which might include an electric motor and a cam that rotates in an eccentric orbit when the electric motor is turned on. A power port 40 is integrated into the outer wall 22 of the pet bed 12 and the power port 40 is electrically coupled to each of the heating element 36 and the vibration unit 38.

A pressure sensor 42 is integrated into the pet bed 12 such that the pressure sensor 42 is engaged when the pet 16 lies on the pet bed 12. The pressure sensor 42 is in communication with each of the heating element 36 and the vibration unit 38 and each of the heating element 36 and the vibration unit 38 is turned on when the pressure sensor 42 is engaged. Conversely, each of the heating element 36 and the vibration unit 38 is turned off when the pressure sensor 42 is disengaged. The pressure sensor 42 is integrated into the cushion 30 and the pressure sensor 42 is electrically coupled to each of the heating element 36 and the vibration unit 38. The pressure sensor 42 may have an operational threshold ranging between approximately 1.0 kg and 3.0 kg.

An electronic timer 44 is integrated into the pet bed 12 and the electronic timer 44 is electrically coupled to the pressure sensor 42. The electronic timer 44 is electrically coupled to each of the heating element 36 and the vibration unit 38 and the electronic timer 44 is actuated to countdown a predetermined duration of time when the pressure sensor 42 is engaged. Each of the heating element 36 and the vibration unit 38 is turned off when the electronic timer 44 completes counting down the predetermined duration of time. The pet bed 12 has a cut 46 extending through a back side 48 of the outer wall 22 of the pet bed 12 thereby facilitating the pet bed 12 to be removed from the cushion 30 and the heating element 36 and the vibration unit 38 in the convention of a cover. The pet bed 12 has a closure 50 integrated into the back side 48 of the outer wall 22 and the closure 50 is aligned with the cut 46 for opening and closing the cut 46. Additionally, the pet bed 12 is comprised of a material that can be laundered and the closure 50 may comprise a zipper or other type of releasable, mechanical closure.

A power cord 52 is provided that has a first plug 54 and a second plug 56. The first plug 54 is electrically matable to the power port 40 in the outer wall 22 of the pet bed 12 and the second plug 56 is electrically matable to a power source 58 comprising a female electrical outlet. The power cord 52 has a switch 60 that is positioned between the first plug 54 and the second plug 56 and the switch 60 is positionable in an on position or an off position. The switch 60 breaks a circuit between the first plug 54 and the second plug 56 when the switch 60 is in the off position to inhibit the flow of electricity between the power source and the power port 40. The switch 60 completes the circuit between the first plug 54 and the second plug 56 when the switch 60 is in the on position to facilitate the flow of electricity between the power source and the power port 40.

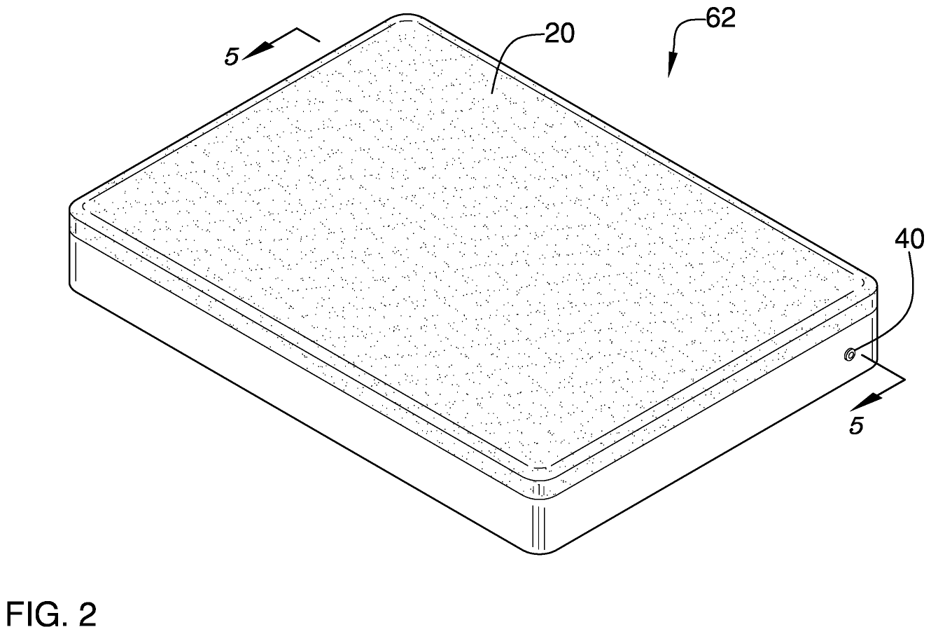

In an alternative embodiment 62 shown in FIGS. 2, 5, 6 and 9, the cushion 30 is positioned beneath the dividing wall 28 in the pet bed 12 and a pillow 64 is positioned between the dividing wall 28 and the top wall 20 of the pet bed 12 such that the pet 16 can lie on the pillow 64. The pillow 64 is comprised of a resiliently compressible material to enhance comfort for the pet 16. Continuing in the alternative embodiment 62, a plurality of massage units 66 is each integrated into the pet bed 12 and each of the massage units 66 is positioned between the top surface of the panel 32 and the cushion 30 such that each of the plurality of massage units 66 is in physical contact with the cushion 30. In this way each of the plurality of massage units 66 massages the pet 16 when the pet 16 lies on the pet bed 12 and the plurality of massage units 66 is turned on.

Each of the massage units 66 includes a motor 68 that is integrated into the pet bed 12 and the motor 68 rotating in a first direction when the motor 68 is turned on. The motor 68 is electrically coupled to the pressure sensor 42 and the motor 68 is turned on when the pressure sensor 42 is engaged. The motor 68 has an output shaft 70 extending toward the cushion 30 and the motor 68 may comprise an electric motor. Each of the massage units 66 includes a plurality of balls 72 that is each positioned between the heating element 36 and the cushion 30. The balls 72 are spaced apart from each other and are evenly distributed around the motor 68.

Each of the massage units 66 includes a plurality of arms 74 and each of the arms 74 has a first end 76 and a second end 78. Each of the plurality of arms 74 lies on a plane that is oriented parallel with top surface 33 of the panel 32. The first end 76 of each of the arms 74 is coupled to an outer surface 80 of a respective one of the balls 72 and the second end 78 of each of the arms 74 is coupled to the output shaft 70 of the motor 68. Each of the plurality of balls 72 is urged to orbit the output shaft 70 when the motor 68 is turned on to massage the pet 16 when the pet 16 lies on the pet bed 12. Additionally, each of the massage units 66 may include a plurality of heating elements that is each integrated into a respective one of the massage balls 72.

In use, the vibration unit 38 and the heating element 36 are turned on when the pet 16 lies on the pet bed 12. In this way the pet 16 is soothed with the vibration and the pet 16 is warmed with the heating element 36. Each of the heating element 36 and the vibration unit 38 are turned off when the pet 16 leaves the pet bed 12. Additionally, each of the vibration unit 38 and the heating element 36 are turned off when the electronic timer 44 finishes counting down the predetermined duration of time. As is described in the alternative embodiment 62 the plurality of massage units 66 are turned on when the pet 16 lies on the pet bed 12 to facilitate the pet 16 to enjoy a soothing massage while the pet 16 lies on the pet bed 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A massaging pet bed assembly for massaging a pet while the pet is resting, said assembly comprising:
a pet bed having a recess integrated into said pet bed wherein said recess is configured to facilitate a pet to lie in said recess;
a cushion being integrated into said pet bed wherein said cushion is configured to have to the pet lie on said cushion, said cushion being comprised of a resiliently compressible material wherein said cushion is configured to enhance comfort for the pet;
a heating element being integrated into said pet bed, said heating element being in thermal communication with said pet bed such that said heating element heats said pet bed when said heating element is turned on wherein said heating element is configured to warm the pet when the pet lies on said pet bed; and
a vibration unit being integrated into said pet bed, said vibration unit vibrating said pet bed when said vibration unit is turned on wherein said vibration unit is configured to facilitate the pet to enjoy the sensation of vibration when the pet lies on said pet bed.

2. The assembly according to claim 1, wherein said pet bed has a bottom wall, a top wall and an outer wall extending between said top wall and said bottom wall, said pet bed having a prominence extending upwardly from said top wall, said prominence extending around a full perimeter of said outer wall such that said prominence defines said recess with respect to said top wall, said prominence having a top end being rounded, said pet bed having a dividing wall being positioned between said top wall and said bottom wall.

3. The assembly according to claim 2, wherein said cushion extends between said dividing wall and said top wall, said cushion extending into said prominence such that said cushion fills said prominence.

4. The assembly according to claim 1, further comprising a panel having a bottom side resting on an upper surface of said bottom wall of said pet bed, a top surface of said panel being spaced from said dividing wall to define a space between said panel and said dividing wall, said panel being comprised of a rigid material thereby inhibiting said bottom wall of said pet bed from deforming when said pet bed is positioned on a support surface.

5. The assembly according to claim 4, wherein:
said heating element is positioned beneath said dividing wall; and
said vibration unit is positioned between said heating element and said top surface of said panel.

6. The assembly according to claim 2, further comprising:
a power port being integrated into said outer wall of said pet bed, said power port being electrically coupled to each of said heating element and said vibration unit; and
a power cord having a first plug and a second plug, said first plug being electrically matable to said power port in said outer wall of said pet bed, said second plug being electrically matable to a power source comprising a female electrical outlet, said power cord having a switch being positioned between said first plug and said second plug, said switch being positionable in an on position or an off position, said switch breaking a circuit between said first plug and said second plug when said switch is in said off position wherein said switch is configured to inhibit the flow of electricity between the power source and said power port, said switch completing said circuit between said first plug and said second plug when said switch is in said on position wherein said switch is configured to facilitate the flow of electricity between the power source and said power port.

7. The assembly according to claim 1, further comprising a pressure sensor being integrated into said pet bed wherein said pressure sensor is configured to be engaged when the pet lies on said pet bed, said pressure sensor being in communication with each of said heating element and said vibration unit, each of said heating element and said vibration unit being turned on when said pressure sensor is engaged, each of said heating element and said vibration unit being turned off when said pressure sensor is disengaged, said pressure sensor being integrated into said cushion, said pressure sensor being electrically coupled to each of said heating element and said vibration unit.

8. The assembly according to claim 7, further comprising an electronic timer being integrated into said pet bed, said electronic timer being electrically coupled to said pressure sensor, said electronic timer being electrically coupled to each of said heating element and said vibration unit, said electronic timer being actuated to countdown a predetermined duration of time when said pressure sensor is engaged, each of said heating element and said vibration unit being turned off when said electronic timer completes counting down said predetermined duration of time.

9. A massaging pet bed assembly for massaging a pet while the pet is resting, said assembly comprising:
a pet bed having a recess integrated into said pet bed wherein said recess is configured to facilitate a pet to lie in said recess, said pet bed having a bottom wall, a top wall and an outer wall extending between said top wall and said bottom wall, said pet bed having a prominence extending upwardly from said top wall, said prominence extending around a full perimeter of said outer wall such that said prominence defines said recess with respect to said top wall, said prominence having a top end being rounded, said pet bed having a dividing wall being positioned between said top wall and said bottom wall;
a cushion being integrated into said pet bed wherein said cushion is configured to have to the pet lie on said cushion, said cushion being comprised of a resiliently compressible material wherein said cushion is configured to enhance comfort for the pet, said cushion extending between said dividing wall and said top wall, said cushion extending into said prominence such that said cushion fills said prominence;
a panel having a bottom side resting on an upper surface of said bottom wall of said pet bed, a top surface of said panel being spaced from said dividing wall to define a space between said panel and said dividing wall, said panel being comprised of a rigid material thereby inhibiting said bottom wall of said pet bed from deforming when said pet bed is positioned on a support surface;
a heating element being integrated into said pet bed, said heating element being in thermal communication with said pet bed such that said heating element heats said pet bed when said heating element is turned on wherein said heating element is configured to warm the pet when the pet lies on said pet bed, said heating element being positioned beneath said dividing wall;
a vibration unit being integrated into said pet bed, said vibration unit vibrating said pet bed when said vibration unit is turned on wherein said vibration unit is configured to facilitate the pet to enjoy the sensation of vibration when the pet lies on said pet bed, said vibration unit being positioned between said heating element and said top surface of said panel;
a power port being integrated into said outer wall of said pet bed, said power port being electrically coupled to each of said heating element and said vibration unit;
a pressure sensor being integrated into said pet bed wherein said pressure sensor is configured to be engaged when the pet lies on said pet bed, said pressure sensor being in communication with each of said heating element and said vibration unit, each of said heating element and said vibration unit being turned on when said pressure sensor is engaged, each of said heating element and said vibration unit being turned off when said pressure sensor is disengaged, said pressure sensor being integrated into said cushion, said pressure sensor being electrically coupled to each of said heating element and said vibration unit;
an electronic timer being integrated into said pet bed, said electronic timer being electrically coupled to said pressure sensor, said electronic timer being electrically coupled to each of said heating element and said vibration unit, said electronic timer being actuated to countdown a predetermined duration of time when said pressure sensor is engaged, each of said heating element and said vibration unit being turned off when said electronic timer completes counting down said predetermined duration of time; and
a power cord having a first plug and a second plug, said first plug being electrically matable to said power port in said outer wall of said pet bed, said second plug being electrically matable to a power source comprising a female electrical outlet, said power cord having a switch being positioned between said first plug and said second plug, said switch being positionable in an on position or an off position, said switch breaking a circuit between said first plug and said second plug when said switch is in said off position wherein said switch is configured to inhibit the flow of electricity between the power source and said power port, said switch completing said circuit between said first plug and said second plug when said switch is in said on position wherein said switch is configured to facilitate the flow of electricity between the power source and said power port.

10. The assembly according to claim 9, wherein:
said cushion is positioned beneath said dividing wall in said pet bed; and
said assembly includes a pillow being positioned between said dividing wall and said top wall of said pet bed wherein said pillow is configured to have the pet lie on said pillow, said pillow being comprised of a resiliently compressible material wherein said pillow is configured to enhance comfort for the user.

11. The assembly according to claim 9, further comprising a plurality of massage units, each of said massage units being integrated into said pet bed, each of said massage units being positioned between said top surface of said panel and said cushion such that each of said plurality of massage units is in physical contact with said cushion wherein each of said plurality of massage units is configured to massage the pet when the pet lies on said pet bed and said plurality of massage units is turned on.

12. The assembly according to claim 11, wherein each of said massage units comprises:
a motor being integrated into said pet bed, said motor rotating in a first direction when said motor is turned on, said motor being electrically coupled to said pressure sensor, said motor being turned on when said pressure sensor is engaged, said motor having an output shaft extending toward said cushion;
a plurality of balls, each of said balls being positioned between said heating element and said cushion, said plurality of balls being spaced apart from each other and being evenly distributed around said motor; and
a plurality of arms, each of said arms having a first end and a second end, each of said plurality of arms lying on a plane being oriented parallel with top surface of said panel, said first end of each of said arms being coupled to an outer surface of a respective one of said balls, said second end of each of said arms being coupled to said output shaft of said motor, each of said plurality of balls being urged to orbit said output shaft when said motor is turned on wherein said plurality of balls is configured to massage the pet when the pet lies on said pet bed.
